(19) United States
(12) Patent Application Publication
(10) Pub. No.: US 2008/0080678 A1
(43) Pub. Date: Apr. 3, 2008

(54) METHOD AND SYSTEM FOR PERSONALIZED VOICE DIALOGUE

(75) Inventors: Changxue C. Ma, Barrington, IL (US); Yan Ming Cheng, Inverness, IL (US); Steven J. Nowlan, South Barrington, IL (US); Dale W. Russell, Palatine, IL (US); Yuan-Jun Wei, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/536,854

(22) Filed: Sep. 29, 2006

(51) Int. Cl. H04M 11/00

(52) U.S. Cl. 379/88.16

(57) ABSTRACT

A method (10) and system (200) for personalized voice dialogue can include tracking (12) a user's use of voice dialogue states or transitions and progressively offering (16) a user more efficient voice dialogue transitions or states such as voice dialogue transition or states having fewer and fewer words. The tracking of dialog states or transitions can include tracking (14) of repeated use of the dialogue states or transitions. A user can be prompted to create a new transition or state. The prompting (18) and confirmation and verification (20) by the user of a new transition or state can be done using SCXML language. The method can further include instantiating (21) the new transition or state with voice tags or words and performing (22) speech recognition using the new transition or state. The method can again determine (23) if the new transition or state is a repeat transition or state.

### FIELD

This invention relates generally to speech recognition systems, and more particularly to a method and system of personalizing a voice dialogue system.

### BACKGROUND

Cell phones are pervasive communication devices and voice dialogue systems have provided a greater ease of use for these complex devices. The design of such dialogue systems have also progressed significantly. However, such systems have been devised for a wide audience of users. The dialogue flow has been crafted very carefully and tested extensively. The choice of words and syntax has been optimized for speech recognition accuracy and efficiency. However, the cognitive burden of using such system is shifted to the end-users.

In current systems, the user has to learn and remember the prescribed utterances that satisfy the grammar constraints setup by the dialogue system. The user may not be accustomed to the typical dialogue flow and the dialogue flow likewise may not be accustomed to a user's choice of words and grammar. Furthermore, a user's goal is to achieve the goal or function with the device without chatting with the device. Below are some examples of such design where a voice dialogue system and user might undergo several stages.

In a novice stage or a first case a user and dialogue system might have the following dialogue:

### Case 1

User: Call my friend in Florida.
Sys: which friend?
User: Steve
Sys: which Steve?
User: Smith
   In an experienced staged or second case, the user and dialogue system might have the following dialogue:

### Case 2

User: call steve smith in florida.
   When the user gets more experience with the system, the user can demand a more efficient way to call Steve. This third case is where the user augments the system so that it will adapt to the individual's use. This is a form of personalization of the dialogue flow.

### Case 3

User: florida steve.

However, from a system designer point of view, the system designer does not allow such utterance to be recognized unless the user specifically augments the dialogue system with the user's way of calling Steve. This would require significant training and user input into the voice dialogue system.

### SUMMARY

Embodiments in accordance with the present invention can provide a user of a voice dialogue system a way to make the dialogue flow more efficient for the user. The more efficient dialogue flow or “short-cuts” as contemplated herein can speed up execution of functions, reduce the chances of speech recognition error (since an utterance will tend to be shorter, especially in car driving situations), and enable a more user friendly system since the user can choose the words to express the short-cut. Although macro or short-cut creation based on key-strokes in computers is similar, it is difficult to create and use such short cuts for portable communication devices. Thus, embodiments herein contemplate short-cuts initiated by the system rather then by the user. Such short-cuts can be constrained by the system and can attempt to guarantee system integrity.

In a first embodiment of the present invention, a method of personalized voice dialogue can include the steps of tracking a user's use of voice dialogue states or transitions and progressively offering a user more efficient voice dialogue transitions or states. The method can further include progressively offering more efficient voice dialogue transitions or states such as offering voice dialogue transitions or states having fewer and fewer words. The method can further prompt a user to create a new transition or state with voice. In one embodiment, the method can prompt a user to create a new transition or state using SCXML language. The method can further include instantiating the new transition or state with voice tags or words and performing speech recognition using the new transition or state. The method can further determine if the new transition or state is a repeat transition or state and prompting the user to delete the repeat transition or state. The method can further include directing, organizing and verifying the new transition or state using a voice dialogue system.

In a second embodiment of the present invention, a system of personalized voice dialogue can include a speech recognition system, a presentation device (such as a display or speaker) coupled to the speech recognition system, and a processor coupled to the speech recognition system and presentation device. The processor can be programmed to track a user's use of voice dialogue states or transitions, and progressively offer a user more efficient voice dialogue transitions or states. The processor can be further programmed to prompt a user to create a new transition or state with voice and to instantiate the new transition or state with voice tags or words. The processor can also be programmed to perform speech recognition using the new transition or state. The processor can also determine if the new transition or state is a repeat transition or state and can further prompt the user to delete the repeat transition or state. The system can progressively offer more efficient voice dialogue transitions or states by progressively offering voice dialogue transitions or states having fewer and fewer words. The processor can also be programmed to create a new transition or state using SCXML language.

In a third embodiment of the present invention, a portable wireless communication unit having a system of personalized voice dialogue can include a transceiver, a speech recognition system coupled to the transceiver, a presentation device coupled to the speech recognition system, and a processor coupled to the speech recognition system and presentation device. The processor can be programmed to track a user's use of voice dialogue states or transitions and progressively offer a user more efficient voice dialogue transitions or states. The processor can be further programmed to prompt a user to create a new transition or state with voice and wherein the processor is further programmed to instantiate the new transition or state with voice tags or words. The processor can be further programmed to perform speech recognition using the new transition or state. If the new transition or state is a repeat transition or state, the processor can also be programmed to prompt the user to delete the repeat transition or state.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of personalized voice dialogue in accordance with an embodiment of the present invention.

FIG. 2 is an illustration of a system for personalized voice dialogue in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable a cell phone user to augment the voice dialogue system with their personal choices of words or phrases to accomplish a task more efficiently. Such personalization of a dialogue system can be realized using a state chart control scheme such as defined in the SCXML language (see http://www.w3.org/TR/2006/WD-scxml-20060124/), which is a general-purpose event-based state machine language that can be used as a dialog control language invoking speech recognition, DTMF recognition, speech synthesis, audio record, and audio playback services. Such action simplifies the dialogue and achieves efficiency for the user. What a user can do in such a system is to add new transitions and bypass most dialogue states. Embodiments herein, though, avoid the chaos of a user freely creating short-cuts. The short-cut as contemplated herein can be directed, organized and verified by the dialogue system in contrast to systems where a user can create macros freely.

As a user of a dialogue system herein navigates through the dialogue states, the system can update the usage count for transition or state sequences in the dialogue path. Based on the score of a particular path, the system can recommend alternative transition or state sequences that will improve the user's interaction style with the system.

For example, for the beginner where the user takes the “case 1” approach for a certain number of times, the dialogue system can suggest to the user to use the “case 2” approach. Further if the user takes the case 2 approach a certain number of times; the dialogue system can then suggest the user add a direct branch to the dialogue flow with a short phrase as in the case 3 approach. This can help the user use the dialogue system more effectively. To add such capability to a dialogue system can be done easily by adding extra transitions using the SCXML language.

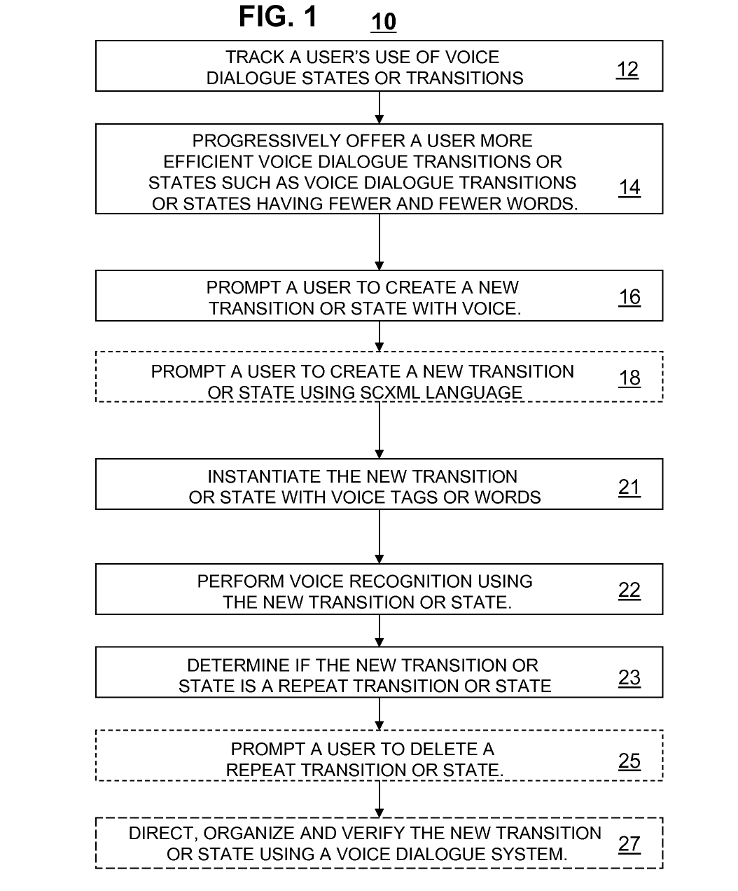

Referring to FIG. 1, a flow chart illustrating a method 10 of personalized voice dialogue can include the step 12 of tracking a user's use of voice dialogue states or transitions and progressively offering a user more efficient voice dialogue transitions or states at step 14. The tracking of dialog states or transitions can include tracking of repeated use of the dialogue states or transitions. The method can further include progressively offering more efficient voice dialogue transitions or states such as offering voice dialogue transitions or states having fewer and fewer words. The method can further prompt a user to create a new transition or state with voice at step 16. In one embodiment, the method can prompt a user to create a new transition or state using SCXML language at step 18. The method 10 can further include the step 21 of instantiating the new transition or state with voice tags or words and performing speech recognition at step 22 using the new transition or state. The method 10 can again determine if the new transition or state is a repeat transition or state at step 23. At step 25, the user can be optionally prompted to delete the repeated transition or state. In the manner shown, the method 10 can thus direct, organize and verify a new transition or state using a voice dialogue system at step 27.

As the user of the dialogue system navigates through the dialogue states, the system can update the usage count for transition or state sequences in the dialogue path. Based on the score of the path, the system can recommend the user to improve his interaction style with the system. Embodiments herein in the form of a subsystem can be easily integrated with a dialogue system. This subsystem can satisfy the needs of a user who gains more exposure to the dialogue flow and wants to personalize the dialogue system. This kind of personalization provides a user with enhanced efficiency when using the system. Thus, a user using the dialogue state corresponding to a simple phrase as found in case 3 will accomplish a function much more quickly than a user utilizing the dialogue state from case 1.

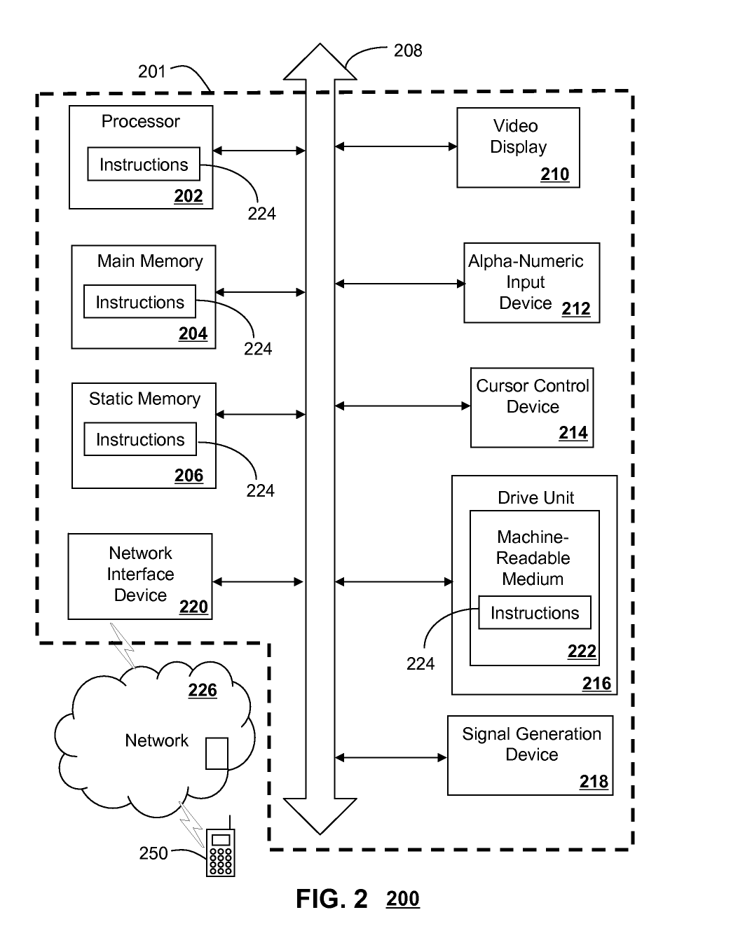

FIG. 2 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of personalized voice dialogue, comprising the steps of:
tracking a user's use of voice dialogue states or transitions; and
progressively offering a user more efficient voice dialogue transitions or states.

2. The method of claim 1, wherein the step of progressively offering more efficient voice dialogue transitions or states comprises the step of offering voice dialogue transitions or states having fewer and fewer words.

3. The method of claim 1, wherein the method further comprises the step of prompting a user to create a new transition or state with voice.

4. The method of claim 3, wherein the method further comprise the step of creating a new transition or state using SCXML language.

5. The method of claim 3, wherein the method further comprises the step of instantiating the new transition or state with voice tags or words.

6. The method of claim 3, wherein the method further comprises the steps of directing, organizing and verifying the new transition or state using a voice dialogue system.

7. The method of claim 3, wherein the method further comprises the step of performing speech recognition using the new transition or state.

8. The method of claim 3, wherein the method further comprises the step of determining if the new transition or state is a repeat transition or state and prompting the user to delete the repeat transition or state.

9. A system of personalized voice dialogue, comprising:
a speech recognition system;
a presentation device coupled to the speech recognition system; and
a processor coupled to the speech recognition system and presentation device, wherein the processor is programmed to:
track a user's use of voice dialogue states or transitions; and
progressively offer a user more efficient voice dialogue transitions or states.

10. The system of claim 9, wherein the processor is further programmed to prompt a user to create a new transition or state with voice.

11. The system of claim 10, wherein the processor is further programmed to instantiate the new transition or state with voice tags or words.

12. The system of claim 11, wherein the processor is further programmed to perform speech recognition using the new transition or state.

13. The system of claim 11, wherein the processor is further programmed to determine if the new transition or state is a repeat transition or state and prompting the user to delete the repeat transition or state.

14. The system of claim 9, wherein the system progressively offers more efficient voice dialogue transitions or states by progressively offering voice dialogue transitions or states having fewer and fewer words.

15. The system of claim 10, wherein the processor is further programmed to create a new transition or state using SCXML language.

16. The system of claim 10, wherein the presentation device comprises a display or a speaker.

17. A portable wireless communication unit having a system of personalized voice dialogue, comprising:
a transceiver;
a speech recognition system coupled to the transceiver;
a presentation device coupled to the speech recognition system; and
a processor coupled to the speech recognition system and presentation device, wherein the processor is programmed to:
track a user's use of voice dialogue states or transitions; and
progressively offer a user more efficient voice dialogue transitions or states.

18. The portable wireless communication unit of claim 17, wherein the processor is further programmed to prompt a user to create a new transition or state with voice and wherein the processor is further programmed to instantiate the new transition or state with voice tags or words.

19. The portable wireless communication unit of claim 18, wherein the processor is further programmed to perform speech recognition using the new transition or state.

20. The portable wireless communication system of claim 18, wherein the processor is further programmed to determine if the new transition or state is a repeat transition or state and prompting the user to delete the repeat transition or state.
